(19) United States
(12) Patent Application Publication
(10) Pub. No.: US 2026/0322860 A1
(43) Pub. Date: Oct. 15, 2026

(54) System, Method, and Device for Integrating Behavioral Monitoring Into Security Monitoring

(71) Applicant: The Toronto-Dominion Bank, Toronto (CA)

(72) Inventors: Doyel GHOSH, Oakville (CA); Vamshidhar PONNAMANENI, Brampton (CA); Vijay Chaitanya BOYINA, Toronto (CA); Rhea MACHADO, London (CA); Pavani MACHHA, Toronto (CA)

(73) Assignee: The Toronto-Dominion Bank, Toronto (CA)

(21) Appl. No.: 19/174,471

(22) Filed: Apr. 9, 2025

(51) Int. Cl. H04L 9/40

(52) U.S. Cl. CPC H04L 63/306; H04L 63/1425; H04L 63/1433

(57) ABSTRACT

System, method and device for integrating behavioral monitoring into security monitoring. The method includes connecting a behavioral monitoring service to an enterprise system and a plurality of client devices, connecting the enterprise system to a security monitoring platform interposed between the plurality of client devices and the enterprise application, storing a set of behavioral monitoring tags at the security monitoring platform, intercepting responses to page requests by client devices which are directed at the enterprise application, assigning an identifier for a session associated with an intercepted page request, adding at least one tag for behavioral monitoring to the intercepted page request, and enabling the behavioral monitoring service to associate monitored behavior of the associated client device to the identifier for the session.

### TECHNICAL FIELD

The following relates generally to methods for security monitoring and, more particularly, to integrating behavioral monitoring into such security monitoring, for example biometric monitoring.

### BACKGROUND

Large enterprises may rely on security-related platforms to perform security-related monitoring on their behalf. For example, certain enterprises may use a fraud detection platform to perform fraud mitigation monitoring. Such a platform may be positioned between user devices and the applications hosted by the institution being accessed by the users. This allows detection of fraudulent activities at the edge computing interface.

Various other security-related mechanisms may be desired depending on the type of organization. For example, an enterprise such as that described above may wish to integrate behavioral monitoring or other types of monitoring with their fraud mitigation strategy. However, it can be difficult to integrate multiple mechanisms together, particularly when the solutions are provided by different vendors.

### BRIEF DESCRIPTION OF THE DRAWINGS

Embodiments will now be described with reference to the appended drawings wherein:

FIG. 1 is a schematic diagram of an example computing environment.

FIG. 2a illustrates a computing system for integrating behavioral and security monitoring for an enterprise system in one configuration.

FIG. 2b illustrates a computing system for integrating behavioral and security monitoring for an enterprise system in another configuration.

FIG. 3 is a flow diagram illustrating a process for integrating behavioral and security monitoring at edge devices.

FIG. 4 is a block diagram of an example configuration for a security monitoring platform.

FIG. 5 is a block diagram of an example configuration for a behavioral monitoring service.

FIG. 6 is a block diagram of an example configuration for an enterprise system.

FIG. 7 is a block diagram of an example configuration of a client device.

FIG. 8 is a flow chart illustrating example operations that may be performed in integrating behavioral and security monitoring.

FIG. 9 is a flow chart illustrating example operations that may be performed in detecting and reacting to high-risk activity.

FIG. 10 is a flow chart illustrating example operations that may be performed in intercepting page requests to establish unique identifiers and attach monitoring tags associated with a page session.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The following describes a system that integrates behavioral monitoring solutions (e.g., BioCatch™) with an edge computing fraud detection solution such one that utilizes the Akamai™ platform. The system can integrate biometric tagging by the behavioral monitoring solution within or otherwise with the fraud detection platform to achieve two goals. First, the behavioral monitoring is done closer to the edge device, thus processing this data more quickly. Second, the configuration offloads the biometric tagging from the application itself to avoid the need to reprogram applications as tags change or are added.

By integrating a behavioral monitoring solution with a security/fraud detection platform as described herein, when a user requests a hosted page from an enterprise's application, done via the fraud detection platform, the response page may be returned to the user via the same platform. At this stage, the platform may intercept the response page in order to generate and store a new identifier for the session. Based on the application type and, possibly, the user type (and/or other criteria), a certain set of biometric tags may be added to the response page. These biometric tags can be used to record various interactions with the application, by the user, for example, mouse, keyboard, and touch events, scrolling and resizing events, interactions with UI fields, hosting device information, and so on during the user session.

When high risk activity is detected, the fraud detection platform can provide this information along with the correct identifier to the application, e.g., to enable remediation actions to be performed, such as shutting out a user. The application can use the identifier to invoke an application programming interface (API) with the behavioral monitoring solution, which is monitoring the activities of the user asynchronously.

In the examples described herein, the behavioral monitoring solution may use behavioral, cognitive, and physiological parameters to create a unique user profile based on user habits and responses within online and mobile applications. For continuous behavioral sequencing, a JavaScript™ tool may record a user journey as they navigate within an application. By integrating behavioral biometrics, supported by machine learning (ML) with the fraud detection edge computing capabilities, the above-noted data can be collected throughout a particular session.

By placing the tagging code in the fraud detection platform, the code is running closer to the end-user to ensure improved performance and faster deployment time.

As an additional advantage, the enterprise can realize improved cyber intelligence and quick behavioral profiling integration to reduce losses due to fraudulent activities. Moreover, the integration described below introduces the ability to perform behavioral profiling on any page without requiring an engineering team's engagement, which can lead to costs saved on change management.

According to one aspect, a computing system for integrating behavioral monitoring into security monitoring is provided. The computing system includes a processor, a communication module coupled to the processor, and a memory coupled to the processor. The memory stores computer executable instructions that when executed by the processor cause the computing system to connect a behavioral monitoring service to an enterprise system and a plurality of client devices, the enterprise system hosting an enterprise application utilized by the plurality of client devices; connect the enterprise system to a security monitoring platform, the security monitoring platform being interposed between the plurality of client devices and the enterprise application; store a set of behavioral monitoring tags at the security monitoring platform; intercept, by the security monitoring platform, responses to page requests by client devices, which are directed at the enterprise application; assign, by the security monitoring platform, an identifier for a session associated with an intercepted page request; add, by the security monitoring platform, at least one tag for behavioral monitoring to the intercepted page request; and enable the behavioral monitoring service to associate monitored behavior of the associated client device to the identifier for the session.

In certain example embodiments, the computing system is further configured to detect high-risk activity performed at the associated client device based on the monitored behavior; and provide the identifier and information related to the high-risk activity to the enterprise application.

In certain example embodiments, providing the information related to the high-risk activity to the enterprise application triggers a subsequent event.

In certain example embodiments, the subsequent event comprises locking the associated client device out of the enterprise application.

In certain example embodiments, the client device utilizes a web browser to access the enterprise application and the behavioral monitoring service records interactions by a user with the web browser during the session using a script.

In certain example embodiments, the behavioral monitoring service records any one of: behavioral, cognitive, and physiological parameters to generate a user profile based on user habits and responses within online-and application-related interactions.

In certain example embodiments, the behavioral monitoring service captures any one of: mouse events, keyboard events, touch events, scrolling events, resizing events, interactions with user interface (UI) fields, or hosting device information.

In certain example embodiments, the behavioral monitoring service communicates with a module at the client device for capturing behavioral data and detecting high-risk behavior.

In certain example embodiments, the behavioral monitoring service is integrated into the security monitoring platform.

In certain example embodiments, the client device comprises a client application for communicating with the enterprise application.

In certain example embodiments, the behavioral monitoring service monitors biometric data.

In another aspect, there is provided a method for integrating behavioral monitoring into security monitoring, the method being implemented by a computing system and comprising: connecting a behavioral monitoring service to an enterprise system and a plurality of client devices, the enterprise system hosting an enterprise application utilized by the plurality of client devices; connecting the enterprise system to a security monitoring platform, the security monitoring platform being interposed between the plurality of client devices and the enterprise application; storing a set of behavioral monitoring tags at the security monitoring platform; intercepting, by the security monitoring platform, responses to page requests by client devices, which are directed at the enterprise application; assigning, by the security monitoring platform, an identifier for a session associated with an intercepted page request; adding, by the security monitoring platform, at least one tag for behavioral monitoring to the intercepted page request; and enabling the behavioral monitoring service to associate monitored behavior of the associated client device to the identifier for the session.

In certain example embodiments, the method further includes detecting high-risk activity performed at the associated client device based on the monitored behavior; and providing the identifier and information related to the high-risk activity to the enterprise application.

In certain example embodiments, providing the information related to the high-risk activity to the enterprise application triggers a subsequent event.

In certain example embodiments, the subsequent event comprises locking the associated client device out of the enterprise application.

In certain example embodiments, the client device utilizes a web browser to access the enterprise application and the behavioral monitoring service records interactions by a user with the web browser during the session using a script.

In certain example embodiments, the behavioral monitoring service records any one of: behavioral, cognitive, and physiological parameters to generate a user profile based on user habits and responses within online-and application-related interactions.

In certain example embodiments, the behavioral monitoring service captures any one of: mouse events, keyboard events, touch events, scrolling events, resizing events, interactions with user interface (UI) fields, or hosting device information.

In certain example embodiments, the behavioral monitoring service communicates with a module at the client device for capturing behavioral data and detecting high-risk behavior.

In another aspect, there is provided a computer readable medium storing computer-executable instructions for integrating behavioral monitoring into security monitoring, comprising computer-executable instructions that, when executed by a computing system, cause the computing system to: connect a behavioral monitoring service to an enterprise system and a plurality of client devices, the enterprise system hosting an enterprise application utilized by the plurality of client devices; connect the enterprise system to a security monitoring platform, the security monitoring platform being interposed between the plurality of client devices and the enterprise application; store a set of behavioral monitoring tags at the security monitoring platform; intercept, by the security monitoring platform, responses to page requests by client devices, which are directed at the enterprise application; assign, by the security monitoring platform, an identifier for a session associated with an intercepted page request; add, by the security monitoring platform, at least one tag for behavioral monitoring to the intercepted page request; and enable the behavioral monitoring service to associate monitored behavior of the associated client device to the identifier for the session.

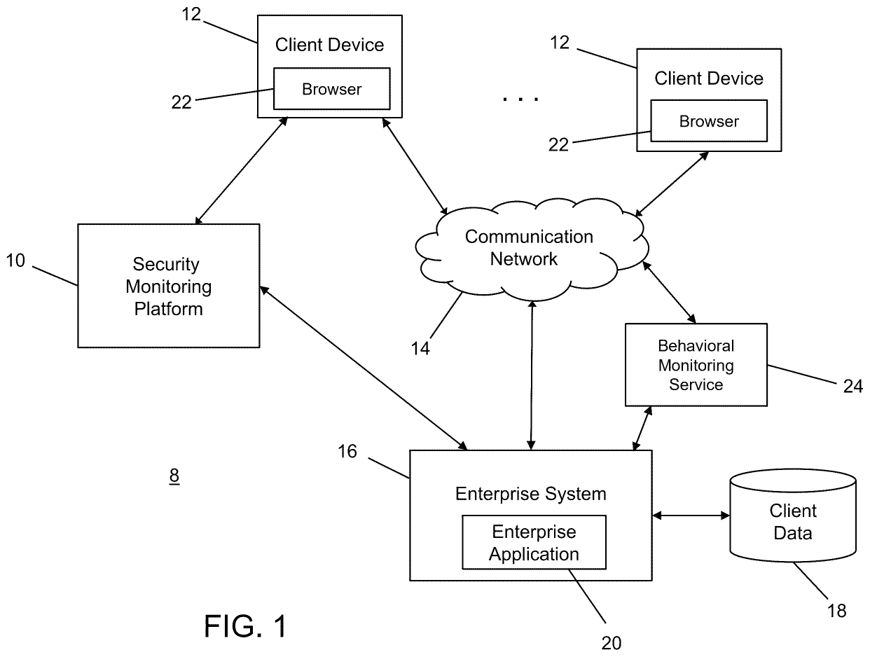

Referring now to the figures, FIG. 1 illustrates an example of a computing environment 8 which may be alternatively referred to herein as the “system” which integrates security and behavioral monitoring. In one aspect, the computing environment 8 may include one or more client devices 12, and one or more communications networks 14 connecting the components of the computing environment 8. The client devices 12 may include or otherwise have access to a security monitoring platform 10 via the communication network 14.

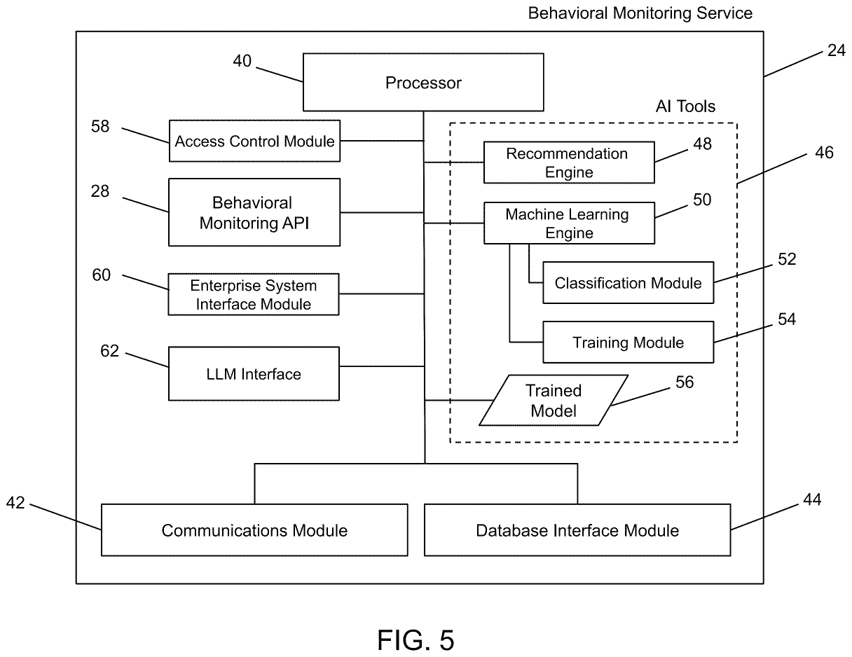

The computing environment 8 may also include an enterprise system 16 (e.g., a financial institution such as commercial bank and/or insurance provider) that provides financial services accounts to users and processes financial transactions associated with those financial service accounts. While several details of the enterprise system 16 have been omitted for clarity of illustration, reference will be made to FIG. 6 below for additional details. The enterprise system 16 includes, at least in part, an enterprise application 20.

The enterprise system 16 also includes or otherwise has access to a datastore for storing client data 18. The enterprise system 16 may include other datastores not shown in FIG. 1. The data associated with a user can include client profile data that may be mapped to corresponding financial data for that user. It can be appreciated that the financial data could also include transaction data and/or the client data 18 shown in FIG. 1 and these datastores are described separately for illustrative purposes. The client data 18 can include both data that is associated with a client as well as data that is associated with one or more user accounts for that client as recognized by the computing environment 8.

The data associated with a client may include, without limitation, demographic data (e.g., age, gender, income, location, etc.), preference data input by the client, and inferred data generated through machine learning, modeling, pattern matching, or other automated techniques. The client data 18 may also include historical interactions and transactions associated with the enterprise system 16, e.g., login history, search history, communication logs, documents, etc.

Client devices 12 may be associated with one or more users. Users may be referred to herein as customers, clients, policy holders, correspondents, or other entities that interact with the security monitoring platform 10 and/or the enterprise system 16 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments.

For example, the user may use client device 12 to engage and interface with a mobile or web-based financial (banking) application which uses or incorporates subsystems of the enterprise system 16, discussed further below. As shown in FIG. 1, the client devices 12 in this example include a browser 22 for accessing web-based applications. It can be appreciated that such client devices 12 may access such applications using stand-alone applications or “apps”.

The client devices 12 can access information within the security monitoring platform 10 and/or enterprise system 16 or another remote computing environment associated with the enterprise system 16 in a variety of ways. For example, the client device 12 can access the security monitoring platform 10 or enterprise system 16 via a web-based application, or a dedicated application. Access can require the provisioning of different types of credentials (e.g., login credentials, two factor authentication, etc.). In example embodiments, each different device 12 can be provided with a unique degree of access, or variations thereof. For example, the client device 12 can be provided with a greater degree of access to the enterprise system 16 compared to other devices.

In the example configuration shown in FIG. 1, the system embodied by the computing environment 8 shown may also include a behavioral monitoring service 24. While shown separately in FIG. 1, as discussed further below, the behavioral monitoring service 24 may be integrated into the security monitoring platform 10 and/or the enterprise system 16.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 16 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Financial institutions can generate vast amounts of data, and have vast amounts of existing records, both of which can be migrated into digital and remote computing environments.

The enterprise system 16 may include both on-premises and remote computing assets provided by a remote computing environment-not shown (hereinafter referred to in the alternative as computing resources). The remote computing environment includes resources used by, or available, to the enterprise system 16 that are stored or managed by a party other than operator of the enterprise system 16. For example, the computing resources can include cloud-based storage services (e.g., database(s)). In at least some example embodiments, the computing resources include one or more tools developed or hosted by the external party, or tools for interacting with the computing resources. In at least one contemplated embodiment, the tool (referred to in the singular for ease of reference) is a tool for managing data lakes, and more specifically a tool for scheduling writing to a data lake associated with the Microsoft™ Azure™ data storage and processing platform. Further particularizing the example, the tool can allow a client device 12 to access the computing resources, and to thereafter configure an ingestion procedure wherein different data files are assigned to different processors (e.g., hardware) within the computing resources based on a configuration file. The tool can be or include aspects of a machine learning tool, or a tool associated with the Delta Lake Storage (ALDS)™ suite, etc. The computing resources can also include hardware resources, such as access to processing capability of server devices (e.g., cloud computing), and so forth.

The security monitoring platform 10 is shown as a separate entity in FIG. 1 for illustrative purposes and, in other configurations, may be part of or otherwise integrated into/with the enterprise system 16. As shown in FIG. 1, the security monitoring platform 10 may be coupled to or in communication with the enterprise application 20, via the enterprise system 16, to permit a user of a client device 12 to obtain a response related to a request that is submitted via the browser 22 and directed through the security monitoring platform 10.

Referring again to FIG. 1, the enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the financial data and/or client data 18 by way of encryption for data protection, digital signatures or message digests for data integrity, and by using digital certificates to authenticate the identity of the users and client devices 12, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

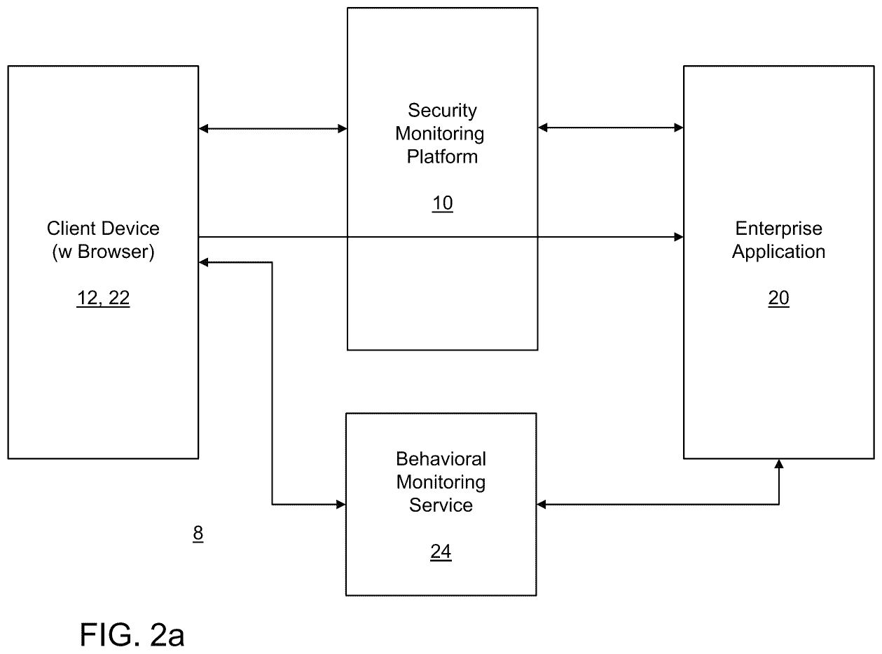

Turning now to FIG. 2a, one example of a configuration for the system or computing environment 8 is shown. In this configuration, the security monitoring platform 10 is interposed between the client device 12 (and its browser 22) and the enterprise application 20. While not shown in FIG. 2a, the enterprise application 20 may be hosted on and by the enterprise system 16. The behavioral monitoring service 24 may be integrated into the computing environment 8 by coupling it to both the client device 12 and the enterprise application 20.

FIG. 2b illustrates another example of a configuration for the system or computing environment 8. In this configuration, the behavioral monitoring service 24 is integrated within the security monitoring platform 10 while being coupled to both the client device 12 and the enterprise application 20 as with the configuration shown in FIG. 2a.

In either configuration, the security monitoring platform 10 can intercept or direct page calls and/or other communications or requests made by the client device 12 via the browser 22 (or other app) to the enterprise application 20 to permit the integrated behavioral and security monitoring to be employed during a particular computing session. The behavioral monitoring service 24 may be invoked via an API or other software interface, e.g., via a secure channel or other connection made via a software development kit (SDK) or similar tool. By integrating the behavioral monitoring service 24 with the security monitoring platform 10 biometric and other tagging can be offloaded from the enterprise application 20 to avoid the need for custom or specialized programming at the enterprise system 16, which can significantly reduce costs and delays with updates to enterprise applications 20.

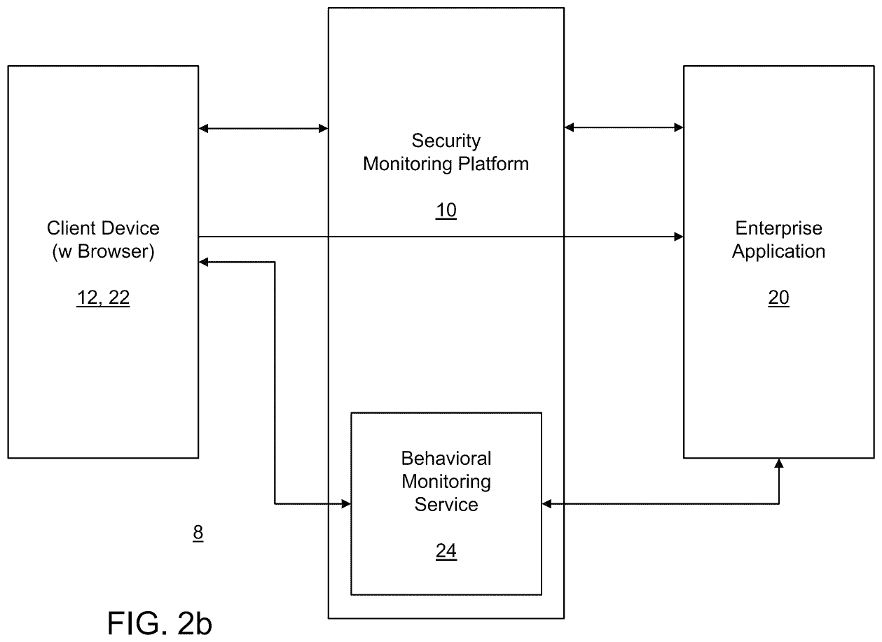

The interactions between the entities of the computing environment 8 as shown in FIGS. 2a and 2b are illustrated by way of example in FIG. 3.

At step 1 in FIG. 3, a request for a hosted page is sent by the client device 12 to the enterprise application 20. The security monitoring platform 10, which is interposed between the client device 12 and the enterprise application 20, intercepts the request intended for the enterprise application 20 and makes its own request at step 2. At step 3, a response page generated by the enterprise application 20 is returned to the security monitoring platform 10. The security monitoring platform 10 generates a client security identifier (CSID), a unique or session-based identifier, or other user or client identifier at step 4. This may be shared with the enterprise application as illustrated in FIG. 3 to enable the enterprise application 20 to correlate any activity reported to it based on the customer/client, session, etc.

At step 5, the security monitoring platform 10 determines suitable tags for biometric or other behavioral monitoring. These tags may be determined using machine learning based on the nature of the enterprise application 20 and/or the type of request being made by the client device 12. For example, requesting sensitive information made trigger the association of different tags than requesting general information outside of a login, etc. At step 6, the security monitoring platform 10 returns the response page to the client device 12 with any tags that have been added. A script or other module in the browser, app, or within the client device 12 itself can utilize the tags during use of the enterprise application 20.

At step 7, the enterprise application 20 invokes an API with the behavioral monitoring service 24 with the CSID generated at step 4. This enables the client device 12 and behavioral monitoring service 24 to exchange asynchronous updates at steps 8.1 through 8.n (where n is an arbitrary number of updates made continuously or intermittently during a session). The behavioral monitoring service 24 may track various interactions in executing the asynchronous updates. For example, mouse events, keyboard events, touch events, scrolling events, resizing events, interactions with user interface (UI) fields, or hosting device information may be detected and reported asynchronously. Those events may be correlated to a spectrum of risky or benign activity, e.g., based on the tags added at steps 5 and 6, or by utilizing a model and machine learning techniques. For example accessing certain areas, in combination with certain actions (e.g., copy, send, etc.) may be determined, using a statistical or machine learning model, to be indicative of corresponding activities. If these can be determined to be risky, the behavioral monitoring service 24 may enable actions to be triggered via the channel between the client device 12 and the security monitoring platform 10, thus achieving an integration of behavioral monitoring in security monitoring.

In this example, at step 9, the client device 12 and/or the behavioral monitoring service 24 detects a high risk activity, e.g., based on one or more of the tags or an analysis using machine learning techniques, statistical modeling, or a combination of any of these monitoring techniques.

At step 10, the client device 12 reports the high risk activity with the associated CSID to the security monitoring platform 10, to enable the security monitoring platform 10 to pass the CSID and notification to the enterprise application 20. In this way, if appropriate, at step 12, remedial action can be taken, such as shutting out or blocking the client device 12 from further activities which could compromise the enterprise application 20 or data within the enterprise system 16. It can be appreciated that, at step 10, the high risk activity may be reported by the behavioral monitoring service 24 or both the client device 12 and the behavioral monitoring service 24, since both have the CSID and are coupled to the enterprise application 20 or security monitoring platform 10.

At step 12, the remedial action may trigger other steps not shown in FIG. 3, which may require further communications between two or more of the entities shown in FIG. 3. Other outside authorities may also be in communication with the enterprise application 20 and be called for such remedial actions.

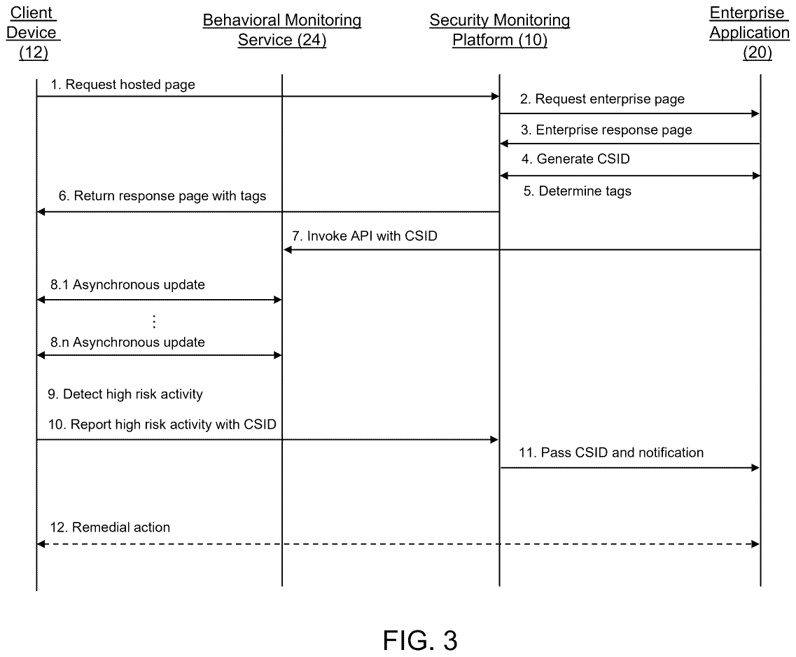

In FIG. 4, an example configuration of the security monitoring platform 10 is shown. In certain embodiments, the security monitoring platform 10 may include one or more processors 40, a communications module 42, and a database interface module 44 for interfacing with the datastores and other data sources, to retrieve, modify, and store (e.g., add) data. Communications module 42 enables the security monitoring platform 10 to communicate with one or more other components of the computing environment 8, such as client device 12, enterprise application 20 or behavioral monitoring service 24, via a bus or other communication network, such as the communication network 14. While not delineated in FIG. 4, the security monitoring platform 10 includes at least one memory or memory device that can include a tangible and non-transitory computer-readable medium having stored therein computer programs, sets of instructions, code, or data to be executed by processor 40.

FIG. 4 illustrates examples of modules, tools and engines stored in memory on the security monitoring platform 10 and executed by the processor 40. It can be appreciated that any of the modules, tools, and engines shown in FIG. 4 may also be hosted externally and be available to the security monitoring platform 10, e.g., via the communications module 42. In the example embodiment shown in FIG. 4, the security monitoring platform 10 includes a suite or set of AI tools 46. The AI tools 46 include or otherwise have access to a recommendation engine 48, a machine learning engine 50, a classification module 52, a training module 54, and at least one trained model 56. The security monitoring platform 10 also includes an access control module 58 and a behavioral monitoring API 28 to provide an interface between the behavioral monitoring service 24 and other entities, such as the security monitoring platform 10. The security monitoring platform 10 also includes an enterprise system interface module 60 to enable it to communicate with the enterprise system 16 and an LLM interface 62 to enable the security monitoring platform 10 and the AI tools 46 to access an LLM (e.g., third party LLM for generating responses to requests, etc.).

The recommendation engine 48 is used by the AI tools 46 of the security monitoring platform 10 to generate one or more recommendations for the security monitoring platform 10 and/or a client device 12 that is/are related to generating Uls, generating code for such Uls, generating test cases, etc. It may be noted that a recommendation as used herein may refer to a prediction, suggestion, inference, association or other recommended identifier that can be used to generate a suggestion, notification, command, instruction or other data that can be viewed, used or consumed by the security monitoring platform 10. The recommendation engine 48 can access data and information and apply one or more inference processes to generate the recommendation(s). The recommendation engine 48 may utilize or otherwise interface with the machine learning engine 50 to both classify data currently being analyzed to generate a suggestion or recommendation, and to train classifiers using data that is continually being processed and accumulated by the security monitoring platform 10. That is, the recommendation engine 48 can learn segmentation outcomes, risk tiers and risk assessments, utilize confusion matrices, etc., and revise and refine classifications, rules or other analytics-related parameters over time. For example, the trained model 56 can be updated and refined using the training module 54 as client devices 12 and/or the behavior monitoring service 24 interact with the security monitoring platform 10 during various interactions to improve the AI/ML parameters and understanding of how certain behaviors (including biometrics) actually indicate risky activity.

The machine learning engine 50 may also perform operations that classify the segmentation and other data (e.g., client data 18) in accordance with corresponding classifications parameters, e.g., based on an application of one or more machine learning algorithms to the data or groups of the data. The machine learning algorithms may include, but are not limited to, a one-dimensional, convolutional neural network model (e.g., implemented using a corresponding neural network library, such as Keras®), and the one or more machine learning algorithms may be trained against, and adaptively improved, using elements of previously classified profile content identifying suitable matches between content identified and potential actions to be executed. Subsequent to classifying the decision-related content or content being analyzed, the recommendation engine 48 may further process each element of the content to identify, and extract, a value characterizing the corresponding one of the classification parameters, e.g., based on an application of one or more additional machine learning algorithms to each of the elements of the decision-related content. By way of example, the additional machine learning algorithms may include, but are not limited to, an adaptive natural language processing (NLP) algorithm that, among other things, predicts starting and ending indices of a candidate parameter value within each element of the content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified content. The LLM interface 62 may be used to additionally access and prompt an LLM (not shown) for creating generative content. Classification parameters may be stored and maintained using the classification module 52, and training data may be stored and maintained using the training module 54.

The trained model 56 may also be created, stored, refined, updated, re-trained, and referenced by the security monitoring platform 10 (e.g., by way of the AI tools 46) to determine associations between actions and outcomes associated with risking behavior, and suitable responses or actions, and/or content related thereto. Such associations can be used to generate recommendations or suggestions for improving decisions being made, e.g., for determining when and how to act on such risky activity.

In some instances, classification data stored in the classification module 52 may identify one or more parameters, e.g., “classification” parameters, that facilitate a classification of corresponding elements or groups of recognized content based on any of the exemplary machine learning algorithms or processes described herein. The one or more classification parameters may correspond to parameters that can indicate an affinity or compatibility between decision parameters and outcomes (e.g., approve or deny), and certain potential actions.

In some instances, the additional, or alternate, machine learning algorithms may include one or more adaptive, NLP algorithms capable of parsing each of the classified portions of the content and predicting a starting and ending index of the candidate parameter value within each of the classified portions. Examples of the adaptive, NLP algorithms include, but are not limited to, NLP models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of event data (e.g., a value or type of data being augmented with an event or workflow) and a single classification parameter and additionally, or alternatively, multiple classification parameters.

Based on the output of the one or more machine learning algorithms or processes, such as the one-dimensional, convolutional neural network model described herein, machine learning engine 50 may perform operations that classify each of the discrete elements of decision-related content as a corresponding one of the classification parameters, e.g., as obtained from classification data stored by the classification module 52.

The outputs of the machine learning algorithms or processes may then be used by the recommendation engine 48 to generate one or more suggested recommendations, instructions, commands, notifications, rules, or other instructional or observational elements that can be presented to the AI tools 46. The AI tools 46 may be used by any one or more of the operations shown in FIGS. 3 and 8-10 described herein. Similarly, the AI tools 46 may use the LLM interface 62 to access third party sources such as GPT-type services that use their own LLMs.

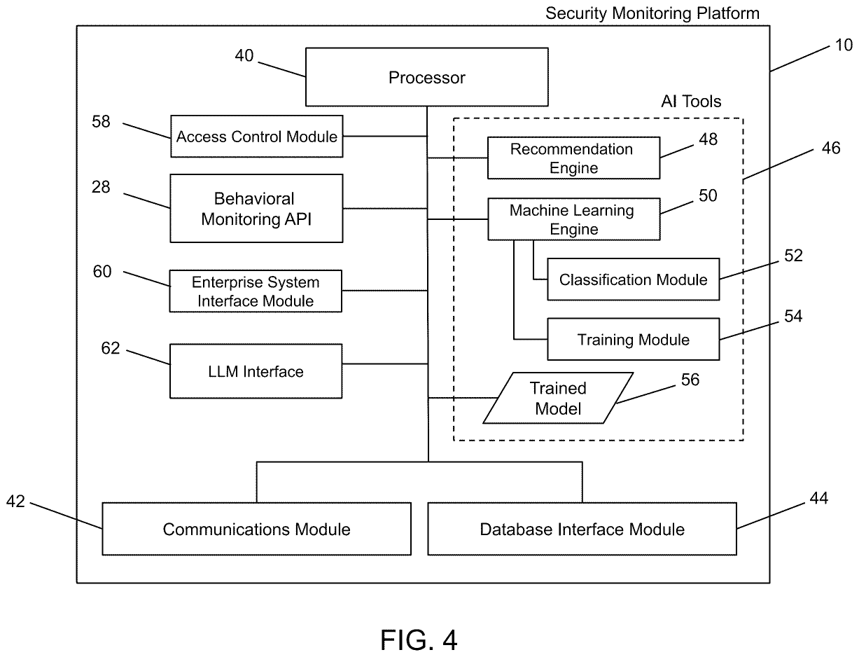

FIG. 5 illustrates an example configuration of the behavioral monitoring service 24 is shown. In certain embodiments, the behavioral monitoring service 24 may include one or more processors 40, a communications module 42, and a database interface module 44 for interfacing with the datastores and other data sources, to retrieve, modify, and store (e.g., add) data. Communications module 42 enables the behavioral monitoring service 24 to communicate with one or more other components of the computing environment 8, such as client device 12, enterprise application 20 or security monitoring platform 10, via a bus or other communication network, such as the communication network 14. While not delineated in FIG. 5, the behavioral monitoring service 24 includes at least one memory or memory device that can include a tangible and non-transitory computer-readable medium having stored therein computer programs, sets of instructions, code, or data to be executed by processor 40.

FIG. 5 illustrates examples of modules, tools and engines stored in memory on the behavioral monitoring service 24 and executed by the processor 40. It can be appreciated that any of the modules, tools, and engines shown in FIG. 5 may also be hosted externally and be available to the behavioral monitoring service 24, e.g., via the communications module 42. In the example embodiment shown in FIG. 5, the behavioral monitoring service 24 includes a suite or set of AI tools 46, which are similar to those utilized by the security monitoring platform 10 (see FIG. 4 and thus certain details thereof will not be repeated). The AI tools 46 include or otherwise have access to a recommendation engine 48, a machine learning engine 50, a classification module 52, a training module 54, and at least one trained model 56. The behavioral monitoring service 24 also includes an access control module 58 and a behavioral monitoring API 28 to provide an interface between the behavioral monitoring service 24 and other entities, such as the security monitoring platform 10. The behavioral monitoring service 24 also includes an enterprise system interface module 60 to enable it to communicate with the enterprise system 16 and an LLM interface 62 to enable behavioral monitoring service 24 and the AI tools 46 to access an LLM (e.g., third party LLM for generating responses to requests, etc.).

In FIG. 6, an example configuration of an enterprise system 16 is shown. The enterprise system 16 includes a communications module 82 that enables the enterprise system 16 to communicate with one or more other components of the computing environment 8, such as the service provider platform 10 and/or client device(s) 12, via a bus or other communication network, such as the communication network 14. While not delineated in FIG. 6, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 6 illustrates examples of servers and datastores/databases operable within the enterprise system 16. It can be appreciated that any of the components shown in FIG. 6 may also be hosted externally and be available to the enterprise system 16, e.g., via the communications module 82. In the example embodiment shown in FIG. 6, the enterprise system 16 includes one or more servers to provide access to client data 18, e.g., for making decisions related to a particular client or entity (e.g., user of client device 12). Exemplary servers include a mobile application server 84, a web application server 86 and a data server 88. The enterprise system 16 also includes the security monitoring platform 10 and the behavioral monitoring service 24. Although not shown in FIG. 6, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storage elements for storing and providing data for use in such services, such as data storage for storing client data 18.

Mobile application server 84 supports interactions with a mobile application installed on client device 12 (which may be similar or the same as a test device). Mobile application server 84 can access other resources of the enterprise system 16 to carry out requests made by, and to provide content and data to, a mobile application on client device. In certain example embodiments, mobile application server 84 supports a mobile banking application to provide payments from one or more accounts of user, among other things.

Web application server 86 supports interactions using a website accessed by a web browser application running on the client device. It can be appreciated that the mobile application server 84 and the web application server 86 can provide different front ends for the same application, that is, the mobile (app) and web (browser) versions of the same application. For example, the enterprise system 16 may provide a banking application that be accessed via a smartphone or tablet app while also being accessible via a browser on any browser-enabled device.

The client data 18 can include, in an example embodiment, financial data that is associated with users of the client devices (e.g., customers of the financial institution). The financial data may include any data related to or derived from financial values or metrics associated with customers of a financial institution system (i.e., the enterprise system 16 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

It will be appreciated that only certain modules, applications, tools and engines are shown in FIGS. 4, 5 and 6 for ease of illustration and various other components would be provided and utilized by the security monitoring platform 10, enterprise system 16, and behavioral monitoring service 24, as is known in the art.

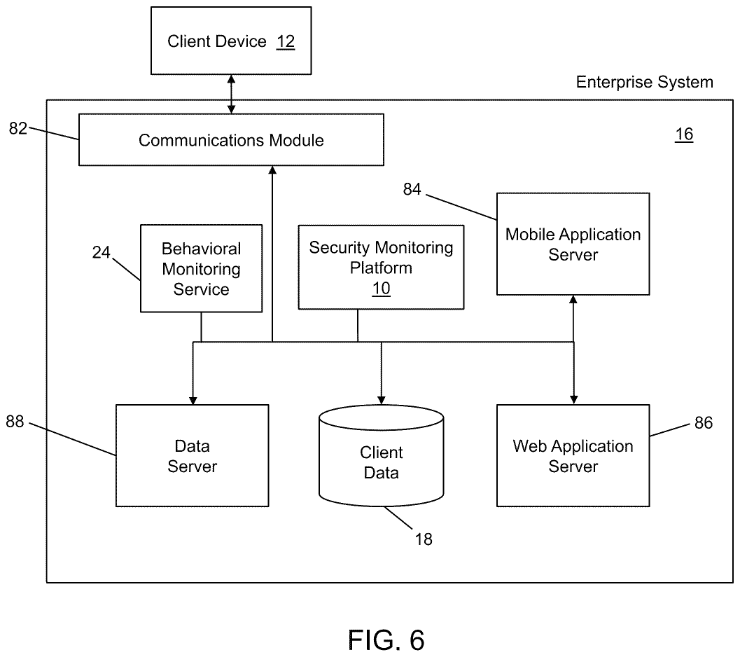

In FIG. 7, an example configuration of a client device 12 is shown. In certain embodiments, the client device 12 may include one or more processors 130, a communications module 132, and a data store 144 storing device data 146 and application data 148. Communications module 132 enables the client device 12 to communicate with one or more other components of the computing environment 8, such as the security monitoring platform 10 and the behavioral monitoring service 24, via a bus or other communication network, such as the communication network 14. While not delineated in FIG. 7, the client device 12 includes at least one memory or memory device that can include a tangible and non-transitory computer-readable medium having stored therein computer programs, sets of instructions, code, or data to be executed by processor 130. FIG. 7 illustrates examples of modules and applications stored in memory on the client device 12 and operated by the processor 130. It can be appreciated that any of the modules and applications shown in FIG. 7 may also be hosted externally and be available to the client device 12, e.g., via the communications module 132.

In the example embodiment shown in FIG. 7, the client device 12 includes a display module 134 for rendering GUIs and other visual outputs on a display device such as a display screen, and an input module 136 for processing user or other inputs received at the client device 12, e.g., via a touchscreen, input button, transceiver, microphone, keyboard, etc. The client device 12 may also include a platform module 138, which may take the form of a customized app, plug-in, widget, or software component provided by the security monitoring platform 10 for use by the client device 12 to use in communicating with the enterprise application 20 via the security monitoring platform 10. Similarly, the client device 12 may include an enterprise system application 142 provided by the enterprise system 16. The client device 12 in this example embodiment also includes the web browser 22 for accessing Internet-based content, e.g., via a mobile or traditional website. The data store 144 may be used to store device data 146, such as, but not limited to, an IP address or a MAC address that uniquely identifies client device 12 within environment 8. The data store 144 may also be used to store application data 148, such as, but not limited to, login credentials, user preferences, cryptographic data (e.g., cryptographic keys), etc.

It will be appreciated that only certain modules, applications, tools and engines are shown in FIGS. 1, 2a, 2b and 4-7 for ease of illustration and various other components would be provided and utilized by the security monitoring platform 10, client device 12, behavioral monitoring service 24, and enterprise system 16 as is known in the art.

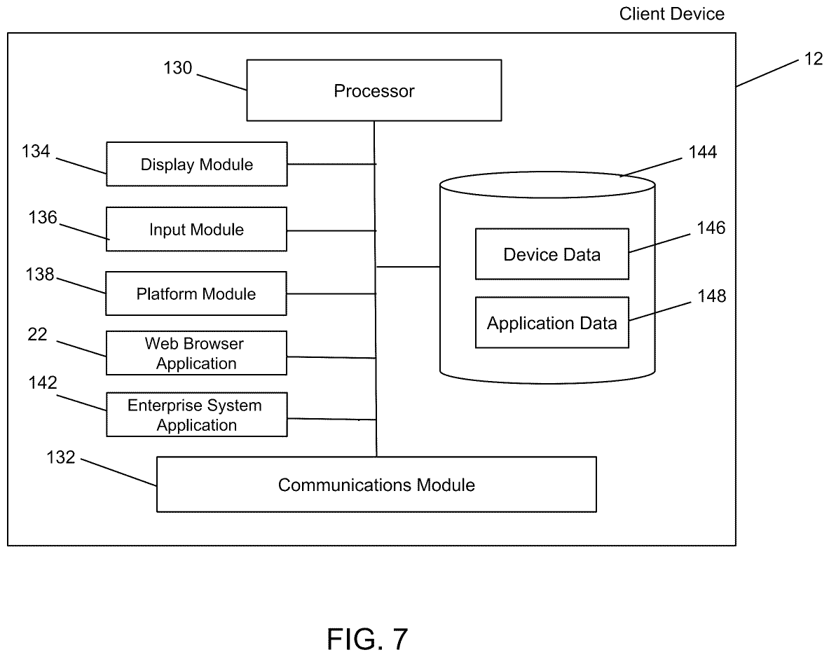

Referring now to FIG. 8, a flow chart illustrates operations that may be performed in to integrating behavioral monitoring into security monitoring, e.g., as shown in FIG. 2a/2b and FIG. 3. At block 200, the system couples the behavioral monitoring service 24 to the enterprise system 16 and the client devices 12. This may be done directly or via the security monitoring platform 10. For example, as shown in FIG. 3, an API such as API 28 shown in FIG. 4 may be invoked to enable the behavioral monitoring service 24 to identify and correlate activities to a particular user identifier.

At block 202, the enterprise system 16 is connected to the security monitoring platform 10, which is interposed between the client devices 12 and the enterprise application 20.

At block 204, a set of behavioral monitoring tags may be stored at the security monitoring platform 10. The tags may be associated with particular activities and/be associated with particular types of applications, particular access credentials, user types, etc. The tags may be used to evaluate user behavior at the client device thus enabling the security platform 10 to integrate behavioral (e.g., biometric) monitoring at the same time.

At block 206, the security monitoring platform 10 intercepts responses to page requests by client devices (e.g., by intercepting and redirecting the request as shown in FIG. 3 or by intercepting the response only). The page requests are directed at the enterprise application 20, e.g., as shown in FIG. 3.

At block 208, the security monitoring platform 10 assigns an identifier for a session that is associated with an intercepted page request (e.g., CSID). At block 210, the security monitoring platform 10 adds at least one of the tags for behavioral monitoring to the intercepted page request such that at block 212, the system can enable the behavioral monitoring service 24 to associate monitored behavior of the associated client device 12 with the identifier for the session.

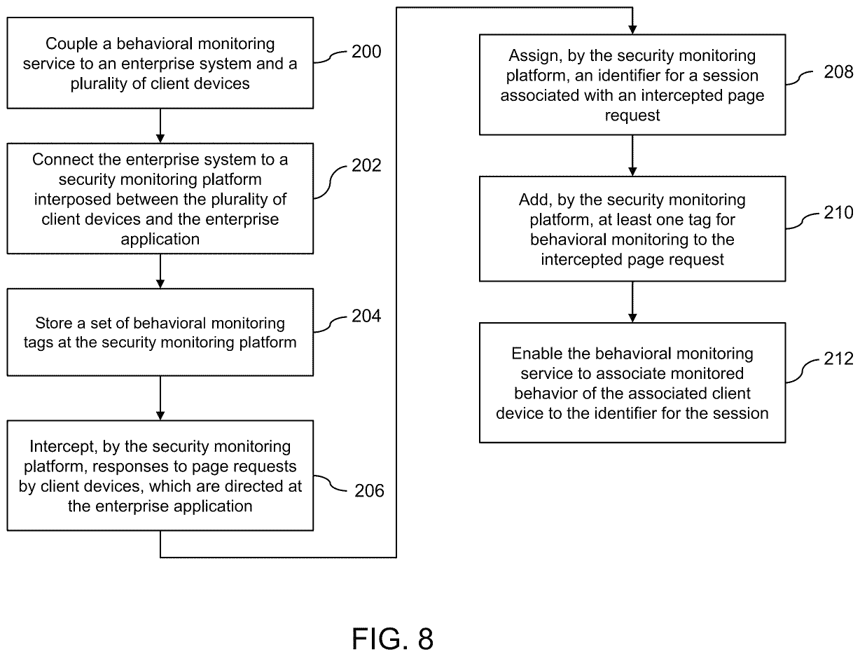

FIG. 9 is a flow chart illustrating example operations that may be performed in detecting and reacting to high-risk activity. At block 220, high risk activity performed at the associated client device 12 is detected, based on the monitored behavior. At block 222, the associated unique identifier and information related to the high-risk activity is provided to the enterprise application 20, e.g., usernames, time stamps, nature of the activity, domains affected, etc.

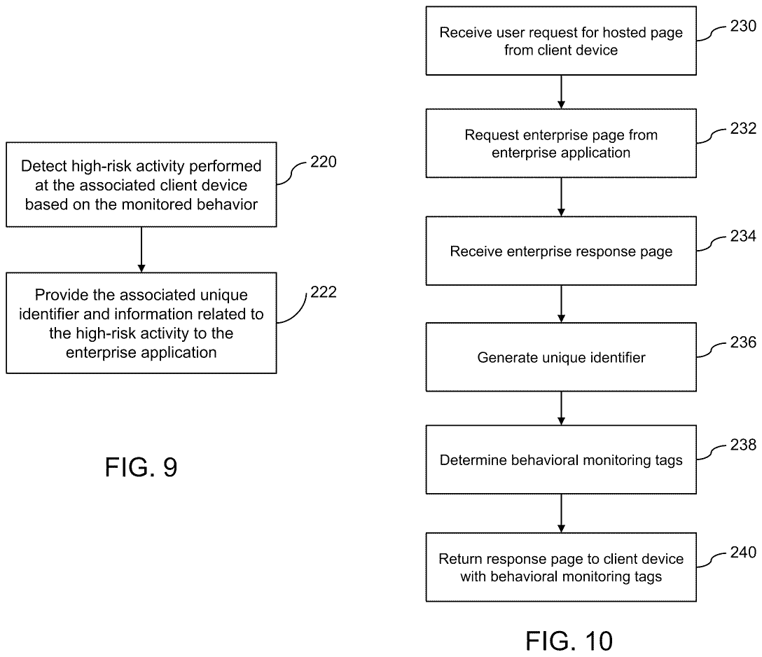

FIG. 10 is a flow chart illustrating example operations that may be performed in intercepting page requests to establish unique identifiers and attach monitoring tags associated with a page session.

At block 230, a user request for a hosted page is received from a client device 12 (e.g., by the security monitoring platform 10 as shown in FIG. 3).

At block 232, the enterprise page is requested from the enterprise application 20. The enterprise response page is received at block 234 and a unique identifier is generated at block 236. At block 238, the behavioral monitoring tags are determined and, at block 240, the response page is returned to the client device 12 with the embedded/attached behavioral monitoring tags.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A computing system for integrating behavioral monitoring into security monitoring, the computing system comprising:
a processor;
a communication module coupled to the processor; and
a memory coupled to the processor, the memory storing computer executable instructions that when executed by the processor cause the computing system to:
connect a behavioral monitoring service to an enterprise system and a plurality of client devices, the enterprise system hosting an enterprise application utilized by the plurality of client devices;
connect the enterprise system to a security monitoring platform, the security monitoring platform being interposed between the plurality of client devices and the enterprise application;
store a set of behavioral monitoring tags at the security monitoring platform;
intercept, by the security monitoring platform, responses to page requests by client devices, which are directed at the enterprise application;
assign, by the security monitoring platform, an identifier for a session associated with an intercepted page request;
add, by the security monitoring platform, at least one tag for behavioral monitoring to the intercepted page request; and
enable the behavioral monitoring service to associate monitored behavior of the associated client device to the identifier for the session.

2. The computing system of claim 1, wherein the system further comprises instructions to:
detect high-risk activity performed at the associated client device based on the monitored behavior; and
provide the identifier and information related to the high-risk activity to the enterprise application.

3. The computing system of claim 2, wherein providing the information related to the high-risk activity to the enterprise application triggers a subsequent event.

4. The computing system of claim 3, wherein the subsequent event comprises locking the associated client device out of the enterprise application.

5. The computing system of claim 1, wherein the client device utilizes a web browser to access the enterprise application and the behavioral monitoring service records interactions by a user with the web browser during the session using a script.

6. The computing system of claim 1, wherein the behavioral monitoring service records any one of: behavioral, cognitive, and physiological parameters to generate a user profile based on user habits and responses within online-and application-related interactions.

7. The computing system of claim 1, wherein the behavioral monitoring service captures any one of: mouse events, keyboard events, touch events, scrolling events, resizing events, interactions with user interface (UI) fields, or hosting device information.

8. The computing system of claim 1, wherein the behavioral monitoring service communicates with a module at the client device for capturing behavioral data and detecting high-risk behavior.

9. The computing system of claim 1, wherein the behavioral monitoring service is integrated into the security monitoring platform.

10. The computing system of claim 1, wherein the client device comprises a client application for communicating with the enterprise application.

11. The computing system of claim 1, wherein the behavioral monitoring service monitors biometric data.

12. A method for integrating behavioral monitoring into security monitoring, the method being implemented by a computing system and comprising:
connecting a behavioral monitoring service to an enterprise system and a plurality of client devices, the enterprise system hosting an enterprise application utilized by the plurality of client devices;
connecting the enterprise system to a security monitoring platform, the security monitoring platform being interposed between the plurality of client devices and the enterprise application;
storing a set of behavioral monitoring tags at the security monitoring platform;
intercepting, by the security monitoring platform, responses to page requests by client devices, which are directed at the enterprise application;
assigning, by the security monitoring platform, an identifier for a session associated with an intercepted page request;
adding, by the security monitoring platform, at least one tag for behavioral monitoring to the intercepted page request; and
enabling the behavioral monitoring service to associate monitored behavior of the associated client device to the identifier for the session.

13. The method of claim 12, further comprising:
detecting high-risk activity performed at the associated client device based on the monitored behavior; and
providing the identifier and information related to the high-risk activity to the enterprise application.

14. The method of claim 13, wherein providing the information related to the high-risk activity to the enterprise application triggers a subsequent event.

15. The method of claim 14, wherein the subsequent event comprises locking the associated client device out of the enterprise application.

16. The method of claim 12, wherein the client device utilizes a web browser to access the enterprise application and the behavioral monitoring service records interactions by a user with the web browser during the session using a script.

17. The method of claim 12, wherein the behavioral monitoring service records any one of: behavioral, cognitive, and physiological parameters to generate a user profile based on user habits and responses within online-and application-related interactions.

18. The method of claim 12, wherein the behavioral monitoring service captures any one of: mouse events, keyboard events, touch events, scrolling events, resizing events, interactions with user interface (UI) fields, or hosting device information.

19. The method of claim 12, wherein the behavioral monitoring service communicates with a module at the client device for capturing behavioral data and detecting high-risk behavior.

20. A non-transitory computer readable medium storing computer-executable instructions for integrating behavioral monitoring into security monitoring, comprising computer-executable instructions that, when executed by a computing system, cause the computing system to:
connect a behavioral monitoring service to an enterprise system and a plurality of client devices, the enterprise system hosting an enterprise application utilized by the plurality of client devices;
connect the enterprise system to a security monitoring platform, the security monitoring platform being interposed between the plurality of client devices and the enterprise application;
store a set of behavioral monitoring tags at the security monitoring platform;
intercept, by the security monitoring platform, responses to page requests by client devices, which are directed at the enterprise application;
assign, by the security monitoring platform, an identifier for a session associated with an intercepted page request;
add, by the security monitoring platform, at least one tag for behavioral monitoring to the intercepted page request; and
enable the behavioral monitoring service to associate monitored behavior of the associated client device to the identifier for the session.
